(19) United States
(12) Patent Application Publication
(10) Pub. No.: US 2006/0143657 A1
(43) Pub. Date: Jun. 29, 2006

(54) Method for displaying broadcasting program guide information and remote controller for the same

(75) Inventor: Min-suk Song, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/319,414

(22) Filed: Dec. 29, 2005

(30) Foreign Application Priority Data
Dec. 29, 2004 (KR) 10-2004-0115344

(51) Int. Cl. H04N 5/445; G06F 13/00; G06F 17/00; G06F 9/00; G06F 3/00

(52) U.S. Cl. 725/52; 725/53; 725/39; 715/786

(57) ABSTRACT

A method for displaying broadcasting program guide (BPG) information, which can promptly provide the BPG information by using a time sliding bar, a channel sliding bar and a hand tool, is provided. The method includes receiving and displaying the BPG information by channel and time, and displaying the time sliding bar, the channel sliding bar and the hand tool so that a viewer may search the BPG information. A remote controller for interacting with a display of the BPG information is also provided. The remote controller includes a first interface part for inputting a command to slidably move the display so that the viewer may search the BPG information, a control signal generator for generating a control signal corresponding to the command input by the first interface part, and a transmitter for transmitting the generated control signal to a broadcast receiving device.

### CROSS-REFERENCE TO RELATED APPLICATIONS

This application claims priority from Korean Patent Application No. 10-2004-0115344, filed on Dec. 29, 2004, in the Korean Intellectual Property Office, the disclosure of which is incorporated herein by reference in its entirety.

### BACKGROUND OF THE INVENTION

1. Field of the Invention

Methods and apparatuses consistent with the present invention relate to displaying broadcasting program guide information, and more particularly, to displaying broadcasting program guide information which can promptly provide broadcasting program guide information a viewer wants to see.

2. Description of the Related Art

A broadcast receiving device provides broadcasting programs of a plurality of channels. Generally, a digital broadcast receiving device provides broadcasting programs of several hundred channels. Therefore, services have been suggested that allow a viewer to easily select a program they want to see from the plurality of channels. An Electronic Program Guide (EPG) is one example of such a service.

The EPG provides information about broadcasting programs through an unused frequency band or a channel for broadcasting a predetermined broadcast signal. In general, the information provided by the EPG includes a timetable that shows the broadcasting programs arranged by channel and time.

In searching broadcasting programs through an EPG on a conventional broadcast receiving device, however, it is not easy for a viewer to search because there are so many channels and programs. For example, in order to search the programs for 7 days of 200 broadcasting stations through the conventional EPG, a huge amount of the viewer's time is needed. If the EPG is able to display the programs for 4 hours of 10 channels in one scene, 20 scene transitions are required to view all of the programs for 4 hours of the 200 channels. Also, 42 scene transitions are required to view all of the programs for 7 days of the 10 channels, and 840 scene transitions are required to view all of the programs for 7 days of the 200 channels.

FIG. 1A is a view of a display that shows broadcasting program guide information (hereinafter referred to as “BPG information”) through a conventional broadcast receiving device, and FIG. 1B is a photograph of a display that shows BPG information through a conventional broadcast receiving device.

Referring to FIG. 1A, the display includes a channel guide portion 101, a time guide portion 103, a selection bar 105, an advertisement portion 107, a picture-in-graphic (PIG) portion 109 and a program guide portion 111. The channel guide portion 101 shows several channel numbers. The time guide portion 103 shows a time schedule. The program guide portion 111 shows program titles by channel and time. The selection bar 105 is a tool for selecting a program, for example, by its program title. When the selection bar 105 selects a program, an image of the selected program appears in the PIG portion 109 at a left side of the display.

However, the conventional EPG needs a large number of scene transitions to provide a listing of the programs a viewer wants to see by channel and time. The scene transitions are accomplished through the selection bar 105 or a page Up/Down key (e.g., of a remote controller device). Therefore, there is a demand for a method that can promptly provide the information a viewer wants to see. Also, the PIG screen provided by the conventional EPG has a fixed size, which is inconvenient. Meanwhile, if a viewing of a certain program is scheduled, the conventional broadcast receiving device provides only text of the scheduled program when the viewing time arrives. However, since such text is less likely to get the viewer's attention, a more effective method for notifying the viewer of the scheduled program viewing is needed.

### SUMMARY OF THE INVENTION

An aspect of the present invention is to provide a method for displaying BPG information through a broadcast receiving device, which can promptly provide BPG information a viewer wants to see.

Another aspect of the present invention is to provide a remote controller which can promptly provide BPG information a viewer wants to see through a broadcast receiving apparatus.

The above aspects are achieved by providing a method for displaying BPG information through a broadcast receiving device. The method comprises receiving and displaying BPG information by channel and time, and displaying a sliding bar so that a viewer can quickly and easily search the BPG information.

The sliding bar may be, for example, a channel sliding bar so that the viewer searches the BPG information by channel.

The sliding bar may be, for example, a time sliding bar so that the viewer searches the BPG information by time.

The displaying of the BPG information may further comprise displaying a selection bar so that the viewer can select the BPG information to be displayed, and displaying the BPG information selected by the selection bar in a picture-in-graphic (PIG) portion. A size of the PIG portion is adjustable.

The displaying of the BPG information may further comprise magnifying or reducing a display of the BPG information.

The displaying of the BPG information may further comprise displaying a hand tool to catch and move the display of the BPG information.

The method may further comprise, when a viewer selects a specific program from the BPG information, displaying only an image of the selected specific program.

The displaying of the selected specific program may comprise displaying, on a picture-in-picture (PIP) screen, a content of a program that a viewer has scheduled to see.

Also, the above aspects are achieved by providing a remote controller for controlling a display of BPG information on a broadcast receiving device from a remote distance. The remote controller comprises a first interface part for inputting a command to slidably move a display so that a viewer can search the BPG information, a control signal generator for generating a control signal corresponding to the command input through the first interface part, and a transmitter for transmitting the generated control signal to the broadcast receiving device.

The first interface part may be, for example, a time scroll bar so that a viewer searches the BPG information by time.

The first interface part may be, for example, a channel scroll bar so that a viewer searches the BPG information by channel.

The remote controller may further comprise a zoom-in/zoom-out button or buttons in order for a viewer to input a command to magnify and reduce the display of the BPG information, and the control signal generator additionally generates a control signal corresponding to the command input through the zoom-in/zoom-out button or buttons.

The remote controller may further comprise a hand tool button for a viewer to input a command to activate a hand tool and catch the display of the BPG information, and the control signal generator additionally generates a control signal corresponding to the command input through the hand tool button.

The remote controller may further comprise a move button in order for a viewer to input a command to move the display caught by the hand tool button, and the control signal generator additionally generates a control signal corresponding to the command input through the move button.

### BRIEF DESCRIPTION OF THE DRAWINGS

The above and other aspects of the present invention will become more apparent by describing exemplary embodiments of the present invention with reference to the accompanying drawings, in which:

FIG. 1A is a view of BPG information displayed by a conventional broadcast receiving device;

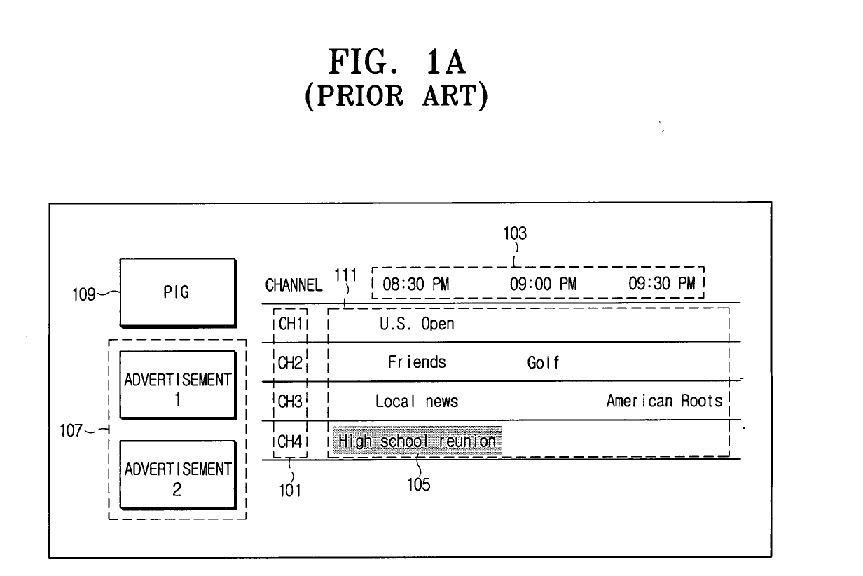

FIG. 1B is a photograph showing a display of BPG information displayed by a conventional broadcast receiving device;

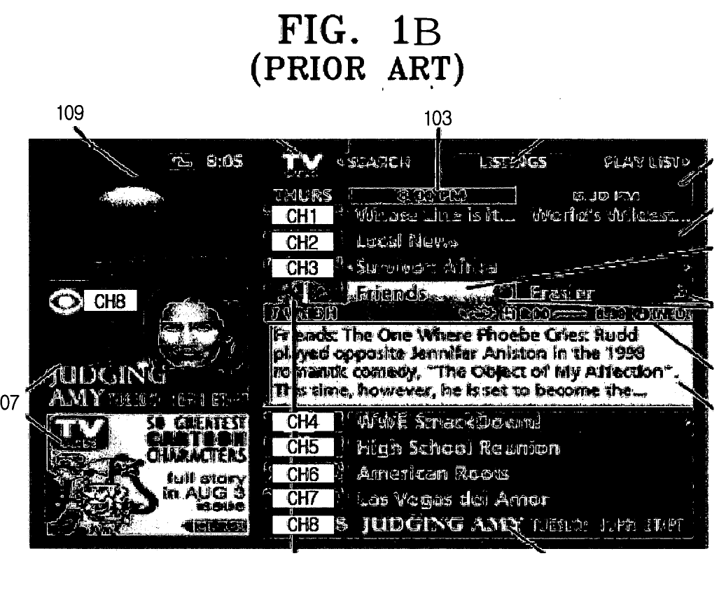

FIG. 2A is a view showing a display of BPG information according to an exemplary embodiment of the present invention;

FIG. 2B is a view showing the display of FIG. 2A after a time slide bar is moved;

FIG. 2C is a view showing the display of FIG. 2A after a channel slide bar is moved;

FIG. 2D is a photograph showing a display of BPG information according to an exemplary embodiment of the present invention;

FIG. 3 is a photograph showing a display that questions if a viewer wants to see a scheduled program;

FIG. 4A is a view of the display of FIG. 2A after zooming-out;

FIG. 4B is a view of the display of FIG. 2A after zooming-in;

FIG. 5 is a block diagram showing a broadcast receiving device adopting a method for displaying BPG information according to an exemplary embodiment of the present invention; and

FIG. 6 is a block diagram showing a remote controller for controlling a broadcast receiving device adopting a method for displaying BPG information according to an exemplary embodiment of the present invention.

### DETAILED DESCRIPTION OF EXEMPLARY EMBODIMENTS

Hereinafter, exemplary embodiments of the present invention will now be described in greater detail with reference to the accompanying drawings.

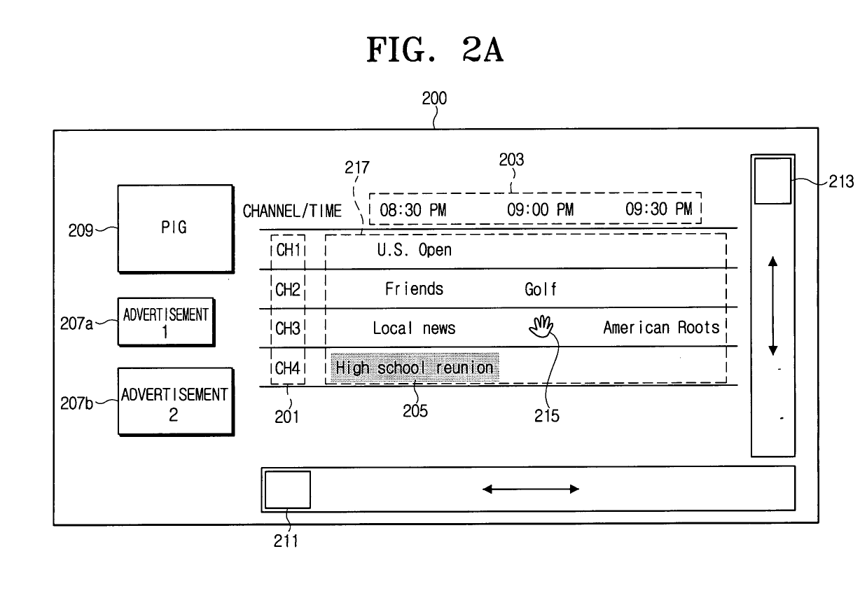

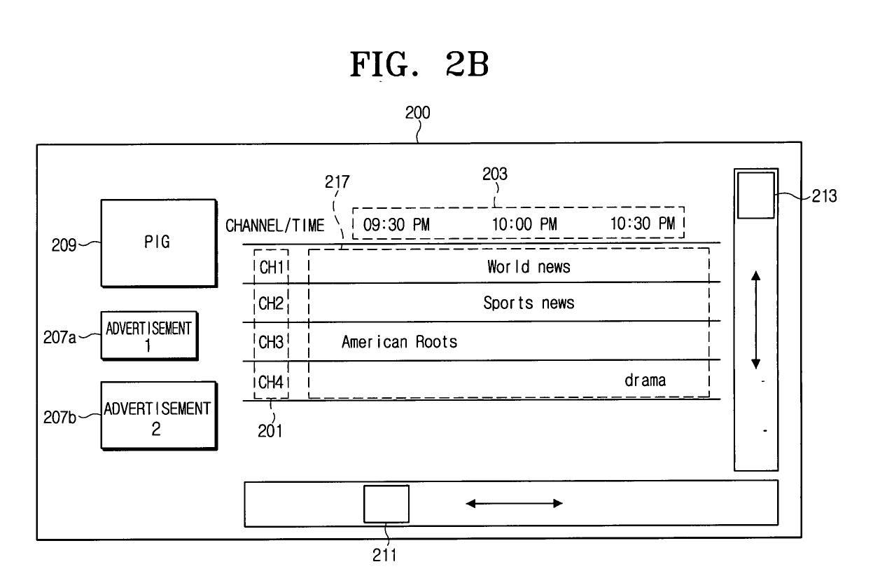

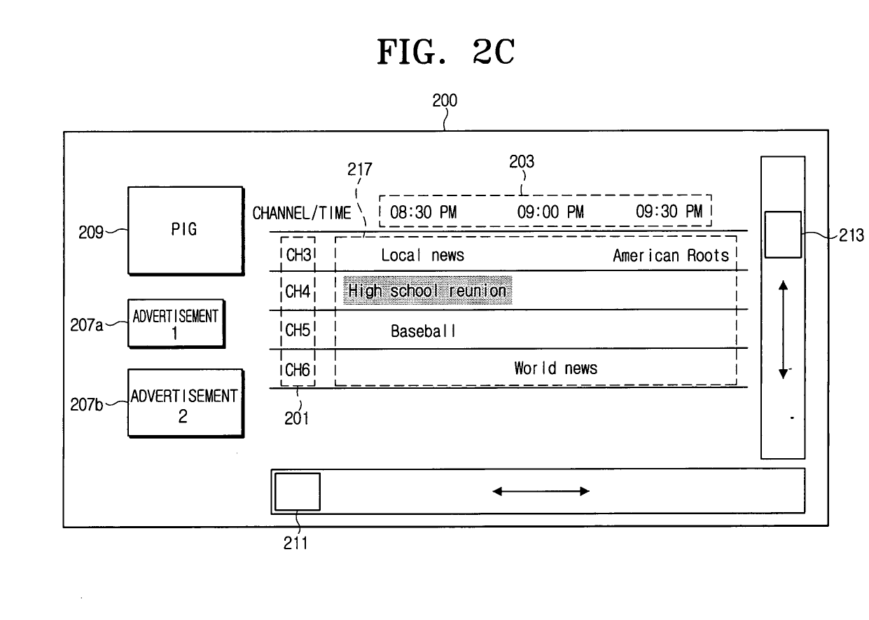

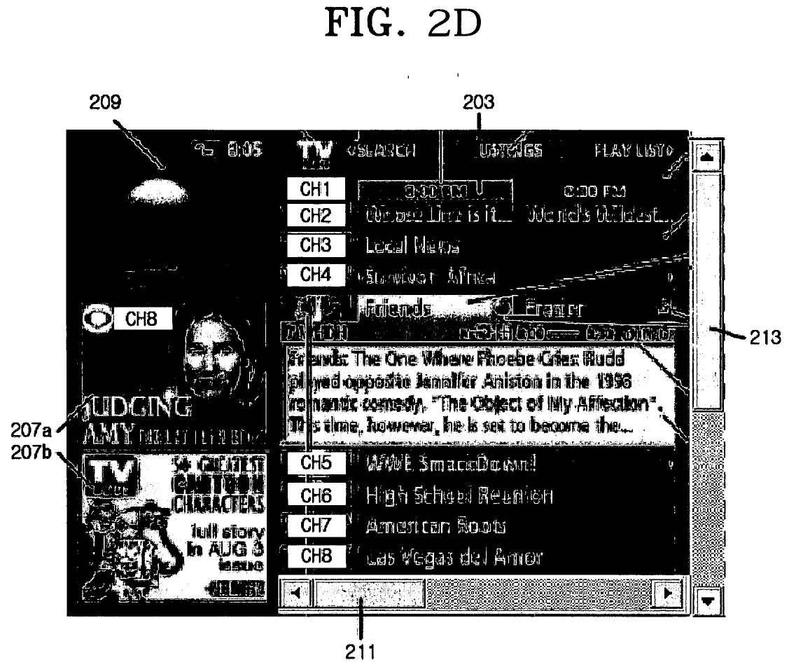

FIG. 2A is a view showing a display of BPG information according to an exemplary embodiment of the present invention.

A display screen 200 comprises a channel guide portion 201, a time guide portion 203, a selection bar 205, a first and a second advertisement portion 207a, 207b, a picture-in-graphic (PIG) portion 209, a time sliding bar 211, a channel sliding bar 213, a hand tool 215, and a program guide portion 217.

The channel guide portion 201 shows several channel numbers. In this exemplary embodiment, the channel guide portion 201 sequentially displays the channel numbers. In another exemplary embodiment, the channel guide portion 201 displays the channel numbers by broadcasting stations.

The time guide portion 203 shows a time schedule. In this exemplary embodiment, the time guide portion 203 shows the time schedule having 30-minute intervals. In another exemplary embodiment, the time guide portion 203 shows the time schedule with one hour intervals.

The program guide portion 217 displays program titles by channel and time. Preferably, but not necessarily, the program titles are displayed on intersections of a time axis and a channel axis. For example, the program titled “U.S. Open” is broadcasted on channel 1 at 08:30 PM as shown in FIG. 2A.

The selection bar 205 is a tool for selecting a program. The selection bar 205 is movable on a guide program item by item. Referring to FIG. 2A, the program titled “High school reunion” is selected by the selection bar 205. In this case, an image of the selected program “High school reunion” appears in the PIG portion 209, which will be described below.

If a program is on the air and is selected by the selection bar 205, the selected program appears in the PIG portion 209. A viewer can see the image of the current program by simply moving the selection bar 205 on the guide program.

The advertisement portions 207a, 207b show advertisements. Graphics or images are displayed in the advertisement portions 207a, 207b. Preferably, but not necessarily, the sizes of the advertisement portions 207a and 207b are adjustable according to a viewer's setting.

The PIG portion 209 displays the image of the program selected by the selection bar 205. Preferably, but not necessarily, the size of the PIG portion 209 is adjustable according to a viewer's setting.

The time sliding bar 211 is movable to the left and right sides so that the display is slidably moved to the left and right sides. When the time sliding bar 211 is moved, the display moves in parallel to the time guide portion 203. FIG. 2B is a view showing the display of FIG. 2A after the time sliding bar 211 is moved. Referring to FIG. 2B, the display shows program titles that are scheduled for broadcast at 09:30 PM, 10:00 PM and 10:30 PM on channels CH1, CH2, CH3 and CH4. Preferably, but not necessarily, if the time sliding bar 211 is further moved to the right, guide information about programs scheduled for broadcast after 10:30 PM is displayed. In an exemplary embodiment, when a viewer transmits a request for movement of the time sliding bar 211 through a remote controller (not shown), the time sliding bar 211 is moved accordingly.

As an example, it is assumed that the guide information includes a program schedule for three hours starting at 08:30 PM. If the time sliding bar 211 is located at the farthermost left, the guide information about programs scheduled for broadcast at the start time (i.e., 08:30 PM), as well as 09:00 PM and 09:30 PM, is displayed, and if the time sliding bar 211 is moved to the farthermost right side, the guide information about programs scheduled for broadcast at the end time (i.e., 11:30 PM), as well as 10:00 PM and 10:30 PM, is displayed.

The channel sliding bar 213 is movable up and down so that the display is slidably moved up and down. When the channel sliding bar 213 is moved, the display moves in parallel to the channel guide portion 201. FIG. 2C is a view showing the display of FIG. 2A after the channel sliding bar 213 is moved. Referring to FIG. 2C, programs that are scheduled for broadcast on channels CH3, CH4, CH5 and CH6 are displayed on the screen. Preferably, but not necessarily, if the channel sliding bar 213 is moved down, program guide information with respect to the next channels is displayed. In an exemplary embodiment, if a viewer transmits a request for movement of the channel sliding bar 213 through a remote controller (not shown), the channel sliding bar 213 is moved accordingly.

As an example, it is assumed that the guide information includes the programs of 10 channels. Preferably, but not necessarily, if the channel sliding bar 213 is located at the highest position, guide information about programs of the first channel (i.e., CH1), as well as channels CH2, CH3 and CH4, is displayed, and if the channel sliding bar 213 is located at the lowest position, guide information about programs of the last channel (i.e., CH10), as well as channels CH7, CH8 and CH9, is displayed.

The hand tool 215 facilitates the movements of the display without using the time and channel sliding bars 211, 213 and without damaging the screen. A viewer moves the display using the hand tool 215. The hand tool 215 has analogous functions to the hand tool of the Acrobat® Reader® (a registered trademark of Adobe Systems Incorporated) program. For example, when a viewer catches the display with the hand tool 215 and then drags the hand tool 215 to the left side, the display of FIG. 2B is shown. Also, when a viewer catches the display with the hand tool 215 and then drags the hand tool 215 to the upper side, the display screen of FIG. 2C is shown. In an exemplary embodiment, when a viewer transmits a hand tool activating command through a remote controller (not shown), the hand tool 215 catches the display.

FIG. 2D is a photograph showing an example of a display of BPG information according to an exemplary embodiment of the present invention. Referring to FIG. 2D, the channel guide portion 201 shows names or graphics of broadcasting stations, such as “ABC”, “FOX”, “CBS”, etc. The time guide portion 203 shows a time schedule such as 08:00 PM and 08:30 PM. The PIG portion 209 is located at the upper left side of the display. Two advertisement portions 207a and 207b are located at the lower left side and the middle left side, respectively. The time sliding bar 211 and the channel sliding bar 213 are also displayed.

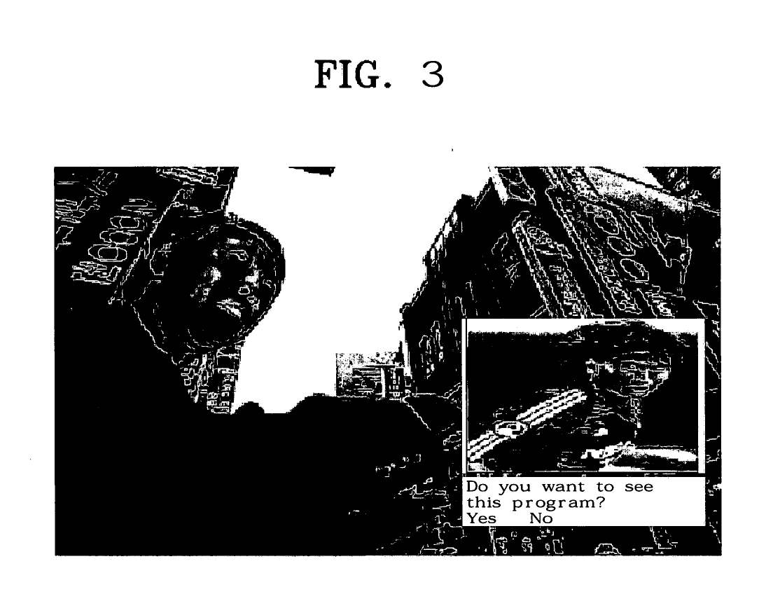

FIG. 3 is a photograph showing a small screen displayed and questioning if a viewer wants to see a scheduled program. This small screen is generally called a picture-in-picture (PIP). The PIP is displayed, questioning if a viewer wants to see a scheduled program, so that the viewer can see the content of the scheduled program. The viewer can, for example, use a remote controller to answer this query.

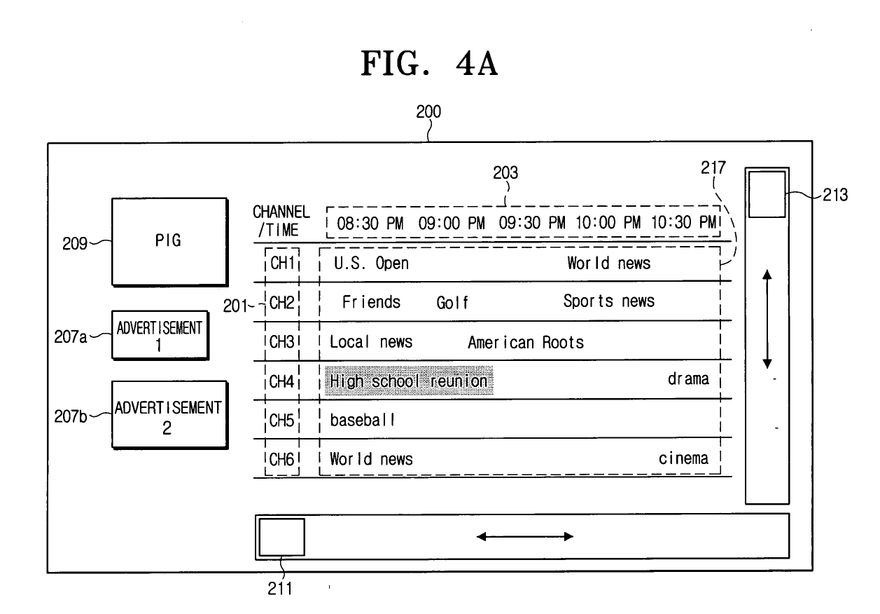

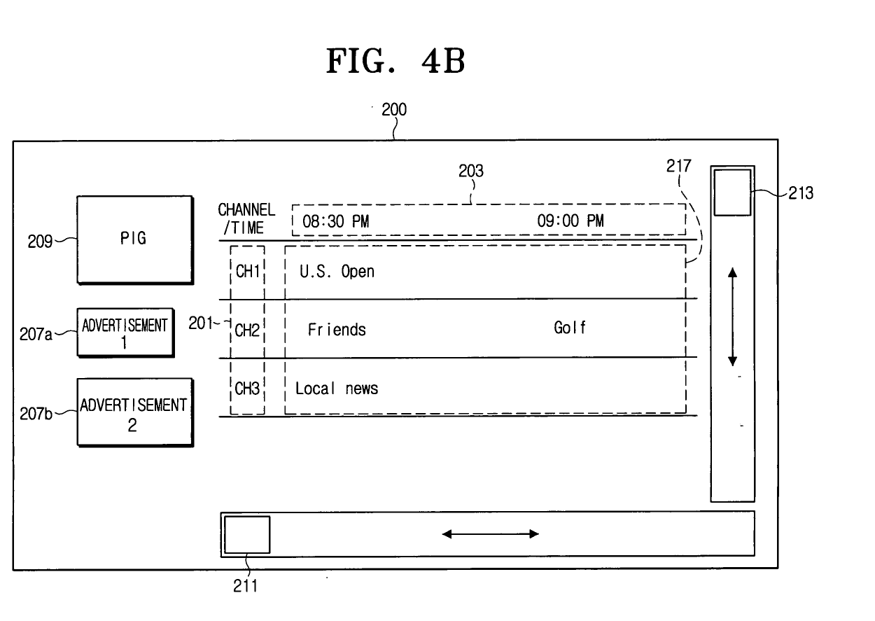

FIG. 4A is a view showing the display of FIG. 2A after zooming-out.

Referring to FIG. 4A, more program guide information is provided by channel and time than provided in the display of FIG. 2A. However, since the text in FIG. 4A is displayed in a smaller size than the text in FIG. 2A, the legibility deteriorates. In an exemplary embodiment, if a viewer transmits a zoom-out command (reduction command) through a remote controller, the display screen of FIG. 4A is provided.

FIG. 4B is a view showing the display of FIG. 2A after zooming-in. Less guide information is displayed in FIG. 4B than provided in the display of FIG. 2A. However, since the text in FIG. 4B is displayed in a larger size than the text in FIG. 2A, the legibility can be improved. In an exemplary embodiment, if a viewer transmits a zoom-in command (magnification command) through a remote controller, the display of FIG. 4B is provided.

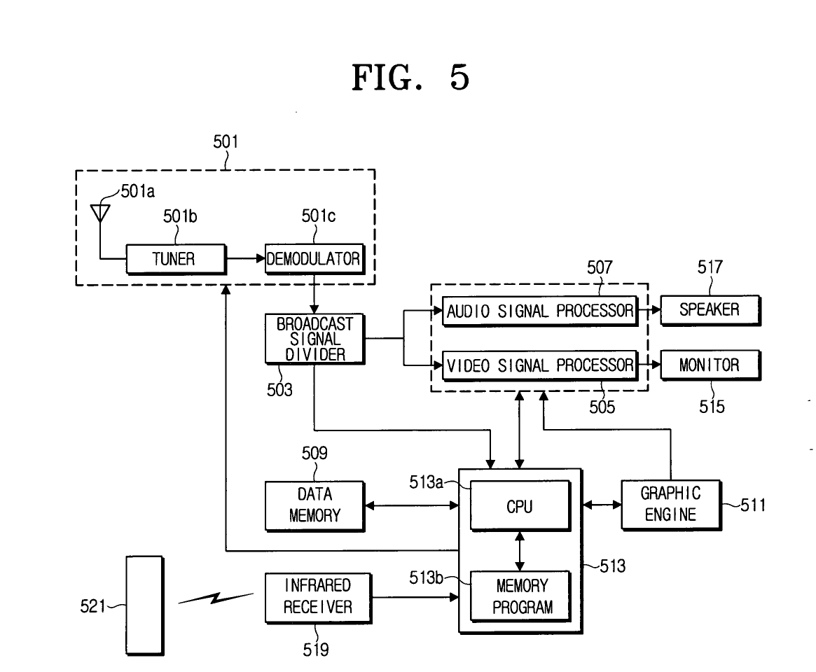

FIG. 5 is a block diagram showing a broadcast receiving device adopting a method for displaying BPG information according to an exemplary embodiment of the present invention.

Referring to FIG. 5, the broadcast receiving device comprises a receiver 501, a broadcast signal divider 503, a video signal processor 505, an audio signal processor 507, a data memory 509, a graphic engine 511, a controller 513, a monitor 515, a speaker 517, an infrared receiver 519, and a remote controller 521.

The receiver 501 comprises an antenna 501a, a tuner 501b, and a demodulator 501c.

From a plurality of broadcast signals received through the antenna 501a, the tuner 501b tunes a broadcast channel that has been selected by a viewer using the remote controller 521. The demodulator 501c demodulates the broadcast signal output from the tuner 501b.

The broadcast signal divider 503 divides the broadcast signal demodulated at the receiver 501 into an audio signal, a video signal, and a data signal, and outputs the audio signal to the audio signal processor 507, the video signal to the video signal processor 505 and the data signal to the data memory 509, respectively. The data signal contains the BPG information.

The audio signal processor 507 processes the audio signal output from the broadcast signal divider 503 into a reproducible signal. For example, the audio signal processor 507 decodes the received audio signal and reproduces it in an analog form.

The video signal processor 505 processes the video signal output from the broadcast signal divider 503 into a reproducible signal. For example, the video signal processor 505 decodes the received video signal and encodes the decoded video signal in an RGB format, thereby generating a displayable video signal. The video signal processor 505 can display the PIP on the screen. Furthermore, the video signal processor 505 can display video data received from the graphic engine 511. The video data transmitted by the graphic engine 511 contains the BPG information.

The data memory 509 stores data output from the broadcast signal divider 503. The stored data contains the BPG information.

The controller 513 controls the receiver 501, the data memory 509, the audio signal processor 507, the video signal processor 505, and the graphic engine 511 such that the broadcast receiving apparatus is operated according to a manipulation command input from a viewer through the remote controller 521.

The controller 513 stores in the data memory 509 the BPG information output from the broadcast signal divider 503.

The controller 513 controls the graphic engine 511 and the video signal processor 505 to display a time sliding bar and a channel sliding bar on the monitor 515.

The controller 513 controls the graphic engine 511 and the video signal processor 505 such that the time sliding bar and the channel sliding bar are slidably moved on the screen according to a viewer's manipulation command input through the remote controller 521.

For example, if the time sliding bar is slidably moved as shown in FIG. 2B, the controller 513 controls the graphic engine 511 and the video signal processor 505 such that BPG information about programs at different times is displayed.

In another example, if the channel sliding bar is slidably moved as shown in FIG. 2C, the controller 513 controls the graphic engine 511 and the video signal processor 505 such that BPG information of programs on different channels is displayed.

The controller 513 controls the graphic engine 511 and the video signal processor 505 such that the display of the program guide information is magnified or reduced according to a viewer's manipulation command input through the remote controller 521.

For example, the controller 513 controls the graphic engine 511 and the video signal processor 505 such that the display of the BPG information is reduced (zoom-out) according to a viewer's display reduction command as shown in FIG. 4A.

In another example, the controller 513 controls the graphic engine 511 and the video signal processor 505 such that the display of the BPG information is magnified (zoom-in) according to a viewer's display magnification command as shown in FIG. 4B.

Also, the controller 513 controls the graphic engine 511 and the video signal processor 505 such that the PIP is displayed to show a program that a viewer has scheduled to see.

For example, the controller 513 controls the graphic engine 511 and the video signal processor 505 such that the PIP as shown in FIG. 3 is displayed to confirm whether a viewer wishes to watch a scheduled program.

In order to accomplish the above functions, the controller 513 comprises a CPU 513a and a program memory 514b.

The CPU 513a executes a program stored in the program memory 514b to thereby perform arithmetic and logic calculations. The program memory 514b stores the program guide information that provides the above-described service. For example, the program memory 514b stores an electronic program guide (EPG) program.

The graphic engine 511 converts data stored in the data memory 509 into image data for display on the monitor 515, and then outputs the data to the video signal processor 505.

The monitor 515 displays the video data output from the video signal processor 505 as an image, and the speaker 517 outputs audio data output from the audio signal processor 507 as sound (e.g., a voice).

The infrared receiver 519 receives infrared rays from the remote controller 521 and outputs a received signal to the controller 513.

The remote controller 521 allows a viewer to input a command to the broadcast receiving device therethrough.

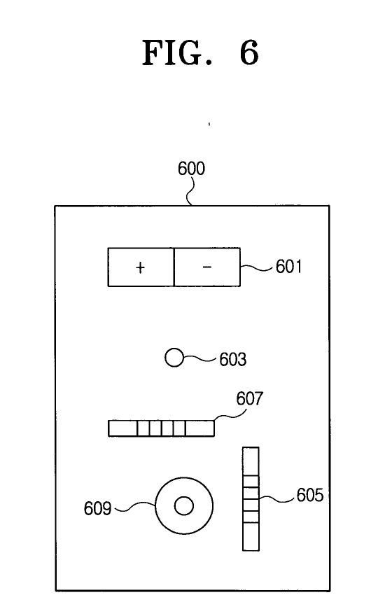

FIG. 6 is a view showing one example of a remote controller for controlling a broadcast receiving apparatus adopting a method for displaying BPG information according to an exemplary embodiment of the present invention.

The remote controller 600 comprises a zoom-in/zoom-out button 601, a hand tool activation button 603, a time scroll bar 607, a channel scroll bar 605 and a move button 609.

When a viewer presses the left side+of the zoom-in/zoom-out button 601, a display is magnified. On the other hand, when the viewer presses the right side of the zoom-in/zoom-out button 601, a display is reduced.

When a viewer presses the hand tool activation button 603, a hand tool 215 is activated to catch the display. After that, the caught display is moved as the hand tool is dragged by the move button 609.

When the time scroll bar 607 is scrolled, BPG information about programs at different times is displayed. By scrolling the time scroll bar 607, the time sliding bar 211 is slidably moved. On the other hand, if the channel scroll bar 605 is scrolled, BPG information about programs on different channels is displayed. By scrolling the channel scroll bar 605, the channel sliding bar 213 is slidably moved.

By moving the move button 609 up and down and right and left, the display is moved up and down and right and left. Preferably, but not necessarily, the move button 609 is a joystick. When the move button 609 is moved with the hand tool activation button 603 being pressed, the display is caught by the hand tool 215 and moved. If the move button 609 is moved in a state that the hand tool button 603 is not pressed, the display moves in sequence.

The remote controller 600 further comprises a control signal generator (not shown) for generating a control signal corresponding to the operations of the zoom-in/zoom-out button 601, the hand tool activation button 603, the time scroll bar 607, the channel scroll bar 605 and the move button 609, and a transmitter for transmitting the control signals generated by the control signal generator. However, their detailed description is omitted as they are well-known technology.

Although in this exemplary embodiment the BPG information is received through an antenna, the present invention is applicable to the BPG information being received through a wire cable.

Also, although in this exemplary embodiment the BPG information is received in data form, the present invention is applicable to the BPG information being received in the form of a video signal.

In the exemplary embodiments described above, a method for displaying the BPG information through the broadcast receiving device promptly provides the BPG information a viewer wants to see by using the time sliding bar 211, the channel sliding bar 213 and the hand tool 215.

Also, since the remote controller 600 according to an exemplary embodiment of the present invention comprises the time scroll bar 607, the channel scroll bar 605, and the hand tool activation button 603, the BPG information can be promptly provided.

The foregoing embodiments are merely exemplary and are not to be construed as limiting the present invention. Many alternatives, modifications, and variations will be apparent to those skilled in the art.

What is claimed is:

1. A method for displaying broadcasting program guide (BPG) information in a broadcast receiving device, the method comprising:
receiving the BPG information;
displaying the BPG information by at least one of a channel and a time; and
displaying a sliding bar for searching the BPG information.

2. The method as claimed in claim 1, wherein the sliding bar is a channel sliding bar for searching the BPG information by channel.

3. The method as claimed in claim 1, wherein the sliding bar is a time sliding bar for searching the BPG information by time.

4. The method as claimed in claim 1, wherein the displaying the BPG information further comprises:
displaying a selection bar which selects the BPG information to be displayed; and
displaying the BPG information selected by the selection bar in a picture-in-graphic (PIG) portion.

5. The method as claimed in claim 4, wherein a size of the PIG portion is adjustable.

6. The method as claimed in claim 1, wherein the displaying the BPG information further comprises increasing a size of the BPG information being displayed.

7. The method as claimed in claim 1, wherein the displaying the BPG information further comprises decreasing a size of the BPG information being displayed.

8. The method as claimed in claim 1, wherein the displaying the BPG information further comprises displaying a hand tool which catches and moves the display of the BPG information.

9. The method as claimed in claim 1, further comprising, if a viewer selects a specific program from the BPG information, displaying only an image of the specific program.

10. The method as claimed in claim 1, further comprising displaying in a picture-in-picture (PIP) screen content of a program that a viewer has scheduled to view.

11. A remote controller for controlling a display of broadcasting program guide (BPG) information in a broadcast receiving device from a remote distance, the remote controller comprising:
a first interface part which inputs a command to slidably move the display to search the BPG information;
a control signal generator which generates a control signal corresponding to the command input through the first interface part; and
a transmitter which transmits the control signal to the broadcast receiving device.

12. The remote controller as claimed in claim 11, wherein the first interface part is a time scroll bar for searching the BPG information by time.

13. The remote controller as claimed in claim 11, wherein the first interface part is a channel scroll bar for searching the BPG information by channel.

14. The remote controller as claimed in claim 11, further comprising a zoom button which inputs a command to increase or decrease a size of the BPG information being displayed, wherein the control signal generator generates a control signal corresponding to the command input through the zoom button.

15. The remote controller as claimed in claim 11, further comprising a hand tool button which inputs a command to activate a hand tool and catch the display of the BPG information, wherein the control signal generator generates a control signal corresponding to the command input through the hand tool button.

16. The remote controller as claimed in claim 15, further comprising a move button which inputs a command to move the display caught by the hand tool button, wherein the control signal generator generates a control signal corresponding to the command input through the move button.
